(19) United States
(12) Patent Application Publication
(10) Pub. No.: US 2023/0296422 A1
(43) Pub. Date: Sep. 21, 2023

(54) RADAR SENSOR WITH SPHERICAL SENSOR HOUSING

(71) Applicant: VEGA GRIESHABER KG, Wolfach (DE)

(72) Inventor: Robert LAUN, Hausach (DE)

(73) Assignee: VEGA GRIESHABER KG, Wolfach (DE)

(21) Appl. No.: 17/996,108

(22) PCT Filed: Apr. 15, 2020
(86) PCT No.: PCT/EP2020/060615

§ 371 Date: May 17, 2023

(51) Int. Cl. G01F 23/284

(52) U.S. Cl. CPC G01F 23/284

(57) ABSTRACT

Radar sensor with an at least sectionally spherical sensor housing, which is rotatably mounted in a mounting device. For example, the sensor housing is spherical.

### SUMMARY

### Field of invention

The invention relates to radar sensors for use in an industrial environment. In particular, the invention relates to a radar sensor having a sensor housing which is rotatably mountable, a mounting device for rotatably mounting such a sensor, the use of such a mounting device for mounting a sensor, a container having a mounting device attached thereto, and a method of mounting a sensor to a container.

### Background

Sensors in the industrial environment can be set up for level measurement, limit level detection, flow measurement, pressure measurement, level and flow velocity measurement and temperature measurement. Such sensors can be designed for mounting on or in an opening of a vessel. They are attached either by means of a flange fastening or a screw-in fastening.

In the case of flange mounting, the sensor, for example a level measuring device or a point level sensor, has a plate-shaped flange which surrounds the antenna neck of the device in a flange-like manner in order to be screwed to a corresponding mating flange in the area of the opening of the container.

In the case of screw-in mounting, the antenna neck itself is equipped with an external thread so that the sensor can be screwed into a corresponding internal thread in a container opening via the external thread.

In addition, it is possible to attach sensors to the vessel by means of mounting clamps, bayonet catches or clamp brackets.

### SUMMARY

It is an object of the invention to provide an alternative means of attaching sensors to a container.

This object is solved by the subject matter of the independent patent claims. Further embodiments of the invention result from the subclaims and the following description of embodiments.

A first aspect of the present disclosure relates to a radar sensor configured to measure a level or a threshold level of a product in a container. The radar sensor comprises a sensor housing, an electronics unit, and an antenna unit. The sensor housing has an outer contour which, at least in a first partial region of the sensor housing, has the form of a spherical segment which is arranged to rotatably support the radar sensor in a corresponding hollow spherical segment of a mounting (i.e. fastening) device. The electronic unit is arranged to generate a measurement signal and the antenna unit is arranged to radiate the measurement signal and to receive the measurement signal reflected from a product surface. The electronic unit and antenna unit are arranged in the housing.

For example, the outer contour of the sensor housing is completely or almost completely spherical.

According to one embodiment, the sensor housing is completely closed.

According to one embodiment, the sensor housing is not completely closed and can be provided, for example, only in the area in which it is mounted in the hollow ball segment. The hollow sphere segment is thus a joint socket.

For example, the sensor housing is made of plastic, at least in the area of the antenna unit, so that the measurement signal can be radiated through the sensor housing. The antenna unit is thus located inside the sensor housing and is protected by it. The sensor housing may be made entirely of plastic, or partially. Other areas of the housing may also be made of other materials, for example metal.

According to a further embodiment, the sensor housing cannot be opened non-destructively. For example, it is manufactured by injection molding, so that the electronics unit and the antenna unit are molded in, for example.

According to one embodiment, the radar sensor is designed as a stand-alone radar sensor (AuRa sensor) with its own internal power supply, for example in the form of a battery.

According to a further embodiment, the radar sensor comprises a radio interface, arranged for wireless transmission of the radar sensor data, which the sensor acquires or calculates, to an external receiver, for example a cell phone or a server.

According to a further embodiment, the center of gravity of the radar sensor is located below the center of the sphere segment so that the radar sensor can align itself perpendicularly to the product surface by means of gravity by rotating into the measuring position. In particular, weights can be provided in the lower part of the sensor, for example in the form of a metal ring running inside the sensor housing, to facilitate the independent alignment of the sensor by gravity.

According to another embodiment, a second portion of the sensor housing comprises a translucent material such that a display of the radar sensor can be read through the sensor housing.

According to a further embodiment, the radar sensor is designed for non-contact measurement of the level or limit level.

Another aspect of the present disclosure relates to a mounting device comprising a hollow sphere or at least one hollow sphere segment configured to rotatably mount a radar sensor described above and below.

According to one embodiment, the mounting device is configured as a closed hollow sphere. It can be made entirely of plastic.

According to a further embodiment, at least the hollow sphere segment is made of opaque plastic.

According to a further embodiment, the hollow sphere or the mounting device consists at least partially of a translucent material, so that a display of the radar sensor can be read through the hollow sphere.

According to another embodiment, the mounting device comprises a fastening flange for attachment to the opening of a container. The mounting device may be of one-piece construction.

According to a further embodiment, the mounting device comprises a retaining arm and/or an internal thread for attaching a retaining arm.

According to a further embodiment, the mounting device comprises a locking element, arranged for fixing the sensor in the mounting device.

According to a further embodiment, the mounting device comprises an alignment element, set up for aligning the sensor in the mounting device.

The sensor and mounting can be designed so that the sensor aligns itself via gravity so that it always radiates vertically downward, or, alternatively, vertically, regardless of the orientation of the mounting device.

According to a further embodiment, the mounting device comprises an alignment element, set up for aligning the sensor in the mounting device.

According to another embodiment, the mounting device has a sensor disposed therein that is rotatably mounted therein.

One could thus say that the mounting device is the housing of the radar sensor. One would thus provide a spherical sensor, for example, which contains an alignment mechanism inside, without any further housing inside. But of course it would also be possible to provide a radar sensor with its own housing and additionally a mounting sphere.

According to a further embodiment, the sensor is a level measuring device, for example a level radar device, a limit level sensor, a pressure sensor or a flow sensor.

Another aspect of the present disclosure relates to the use of a mounting device described above and below for mounting a sensor, for example a sensor described above and below, selectively on a side wall of a container or the ceiling of the container.

Another aspect of the present disclosure relates to a container having a mounting device attached thereto as described above and below.

Another aspect of the present disclosure relates to a method of attaching a sensor to a container. First, arranging the sensor in a fully enclosed mounting device or in an at least partially enclosed mounting device is performed. Thereafter, attaching the mounting device to or in proximity to a container occurs. Simultaneously or thereafter, an alignment of the sensor occurs. For example, the alignment of the sensor takes place by means of gravity, i.e. independently and without the assistance of a user.

The radar sensor can be designed for process automation in an industrial environment. It can be used in agriculture, for monitoring mobile drinking water or feed containers.

The term “process automation in the industrial environment” can be understood as a subfield of technology that includes all measures for the operation of machines and plants without the involvement of humans. One goal of process automation is to automate the interaction of individual components of a plant, for example in the chemical, food, pharmaceutical, petroleum, paper, cement, shipping or mining industries. A wide range of sensors can be used for this purpose, which are adapted in particular to the specific requirements of the process industry, such as mechanical stability, insensitivity to contamination, extreme temperatures and extreme pressures. Measured values from these sensors are usually transmitted to a control room, where process parameters such as level, limit level, flow rate, pressure or density can be monitored and settings for the entire plant can be changed manually or automatically.

One subarea of process automation in the industrial environment concerns logistics automation. With the help of distance and angle sensors, processes within a building or within an individual logistics facility are automated in the field of logistics automation. Typical applications include systems for logistics automation in the area of baggage and freight handling at airports, in the area of traffic monitoring (toll systems), in retail, parcel distribution or also in the area of building security (access control). Common to the examples listed above is that presence detection in combination with precise measurement of the size and position of an object is required by the respective application. Sensors based on optical measurement methods using lasers, LEDs, 2D cameras or 3D cameras that measure distances according to the time-of-flight (ToF) principle can be used for this purpose.

Another sub-area of process automation in the industrial environment concerns factory/production automation. Use cases for this can be found in a wide variety of industries such as automotive manufacturing, food production, the pharmaceutical industry or generally in the field of packaging. The goal of factory automation is to automate the production of goods by machines, production lines and/or robots, i.e. to let it run without the involvement of humans. The sensors used in this process and the specific requirements with regard to measuring accuracy when detecting the position and size of an object are comparable to those in the previous example of logistics automation.

Further embodiments are described below with reference to the figures. The illustrations in the figures are schematic and not to scale. If the same reference signs are used in the following description of the figures, these designate the same or similar elements.

### BRIEF DESCRIPTION OF THE FIGURES

FIG. 1 shows a measurement setup according to a first embodiment.

FIG. 2 shows a measurement setup according to a further embodiment.

FIG. 3 shows a flow diagram of a process according to an embodiment.

FIG. 4 shows a section of a radar sensor with mounting device in the area of the sensor bearing.

### DETAILED DESCRIPTION OF EMBODIMENTS

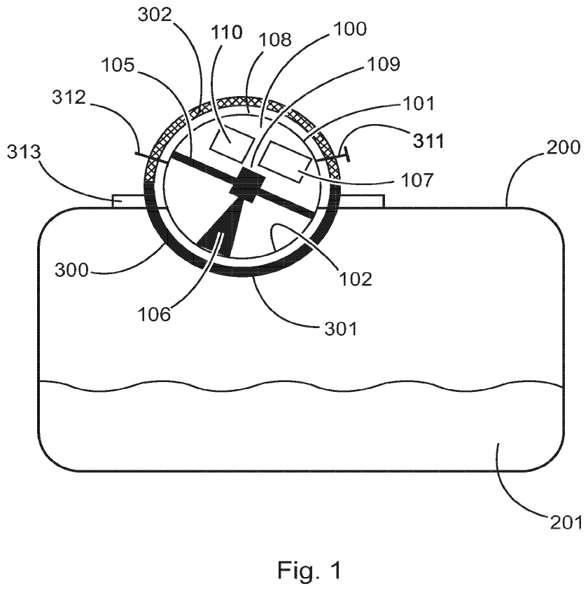

FIG. 1 shows a measurement setup according to an embodiment. The measurement setup has a radar sensor 100 that is mounted in a mounting device 300 in such a way that it can rotate in all spatial directions. The mounting device 300 is attached to the opening of the container 200, for example by means of a flange mounting 313, but other mounting may also be provided and the invention is not limited to a flange mounting.

Importantly, the radar sensor 100 is rotatably mounted in the housing of the mounting device 300.

The radar sensor, which is configured to measure the level or limit level of the product 201, comprises a sensor housing 101, an electronics unit 105 and an antenna unit 106. The sensor housing 101 may be spherical in shape or, alternatively, may have a portion that is shaped like a spherical segment. In the embodiment shown in FIG. 1, the sensor housing is a solid sphere made of plastic and contains the electronics unit 105, the antenna unit 106, the energy storage 110, and a wireless communication module 107.

The wireless communication module 107 may also be referred to as a radio interface. Also, a display 109 may be provided which is located, for example, near the top of the housing so that it can be read through the wall of the housing. For this purpose, the upper, second partial area 108 of the housing is made of translucent material, for example a transparent plastic. Since the spherical electronics unit 100 is completely contained within the outer sphere 300, the sub-region 108 can be saved and the electronics can be placed openly, without an additional housing, within the outer sphere 300.

The lower portion of the housing, further referred to above as the “first sub-region” 102, may also be made of plastic. However, this sub-region need not be translucent; it is sufficient for radar beams emitted from the antenna unit 106 towards the medium to be filled to be translucent. Again, the antenna would not need to be within a housing. It would already be protected by the outer sphere and could be exposed so that it would only be necessary to measure through the outer sphere. In other words, the inner sphere may be reduced to a spherical segment disposed within the socket of the mounting device 300.

The radar sensor 100 is located entirely within the mounting device 300, so the unit may have two parts, a mounting device 300 and a separate radar sensor 100. In another embodiment, the mounting device 300 represents the housing of the radar sensor 100, so the unit 100 could also be referred to as a spherical or spherical segment electronic unit without its own housing.

The mounting device 300 may be a hollow sphere or a hollow sphere segment. Similar to the radar sensor, the housing of the mounting device 300 can also consist of two different materials: First, a hemisphere or hollow sphere segment 301 in the lower region that is transparent to radar beams and an upper hollow sphere segment 302 in the upper region that are detachably or non-detachably connected to each other. The upper hollow sphere segment 302 may be made of the same material as the lower hollow sphere segment, or it may be made of a different material, such as a translucent material, such as a transparent plastic.

A locking element 311 may be provided, for example in the form of a set screw threaded into a continuous internal thread through the wall of the mounting device 300 to clamp the sensor 100 in place.

Also, an alignment element 312 may be provided by means of which the orientation of the sensor 100 can be manually adjusted, for example magnetically through the plastic wall.

It may be provided that the center of gravity of the sensor is located in the area of the antenna unit 106, in any case well below the center of the spherical radar sensor 100, so that the mounted “sensor sphere” automatically adjusts itself by means of gravity so that the antenna measures in the desired direction (usually vertically; however, horizontal measurement or measurement in another direction may also be provided).

Also, the radar sensor can have a tilt sensor that detects the current orientation of the sensor. This data can help to detect or calculate the level more accurately.

An attachment of the radar sensor 100 to the container 200 is thus provided, which allows the antenna unit 106 to be rotated and pivoted in all directions. The device can be manufactured inexpensively in this case.

For example, the mounting device 300 is designed as a two-piece hollow sphere. The radar sensor 100 is spherical in shape and can thus be accommodated in the hollow sphere housing and thus rotated and pivoted in all directions.

The spherical radar sensor 100 can be fixed, for example, by the upper half shell of the hollow sphere. The radar antenna, which is part of the electronics, can thus be pivoted and fixed in all possible positions. Here, measurements are taken through the outer housing sphere 301, 302, which is made of plastic.

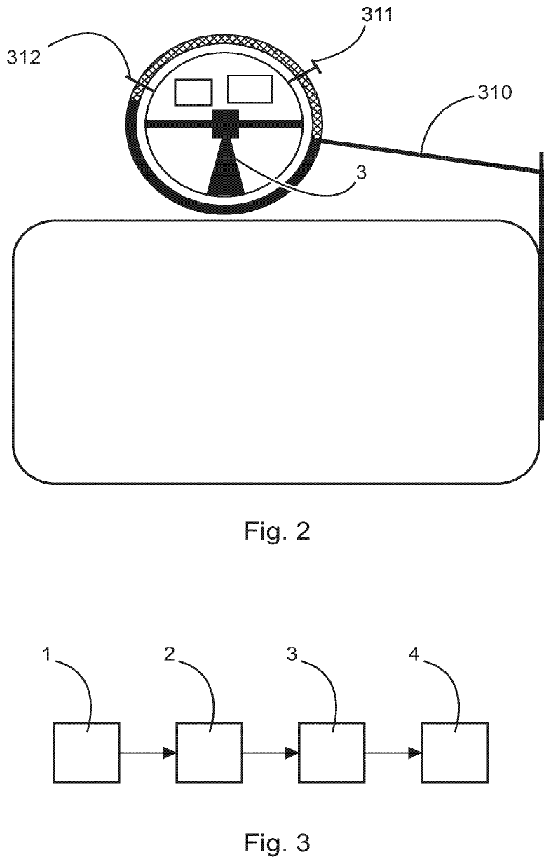

The mounting device can be placed in any round hole of the container that is smaller in diameter than the diameter of the sphere and can be glued in place using a silicone bead, for example. Alternatively, the mounting device 300 can be attached to the container by means of a rod 310 (cf. FIG. 2) or a clamping device so that the spherical mounting device is located outside the container.

If the upper hemisphere 302 is made of transparent plastic, a display or light indicator located inside can be read through the housing wall. Alternatively, it may be provided that the radar sensor 100 is merely inserted into the hemisphere-like housing portion 301 so that it can be easily replaced.

Thus, a spherical device housing is provided that includes a spherical electronics cup with antenna so that the antenna can be vertically oriented in the spherical housing.

If the radar sensor 100 is placed on the container opening with its hollow sphere-like mounting device 300, as shown in FIG. 1, the lower part of the hollow sphere protrudes into the container. This hollow sphere houses the electronics with antenna, which is also in the form of a sphere. The upper part of the sphere housing can be made with transparent plastic so that any display inside remains visible.

A radio interface (wireless module) 107, which uses Bluetooth for example, is provided for communication with an external unit and in particular for measured value transmission or parameterization. To enable completely autonomous operation of the radar sensor, an energy storage device 110, for example a rechargeable battery, can be used.

If no opening in the container is desired, the attachment device 300 can also be mounted to the container, for example, by means of a rod 310, so that it “floats” above the container (see FIG. 2).

FIG. 3 shows a flow diagram of a method according to an embodiment. In step 1, the sensor 100 is arranged in a fully or partially enclosed mounting device 300. In step 2, the mounting device is attached to a container, and in step 3, the sensor is aligned so that it emits the measurement signal perpendicular to the product surface. The alignment can be done automatically by gravity. In step 4, the sensor is locked in place, whereupon the level measurement takes place.

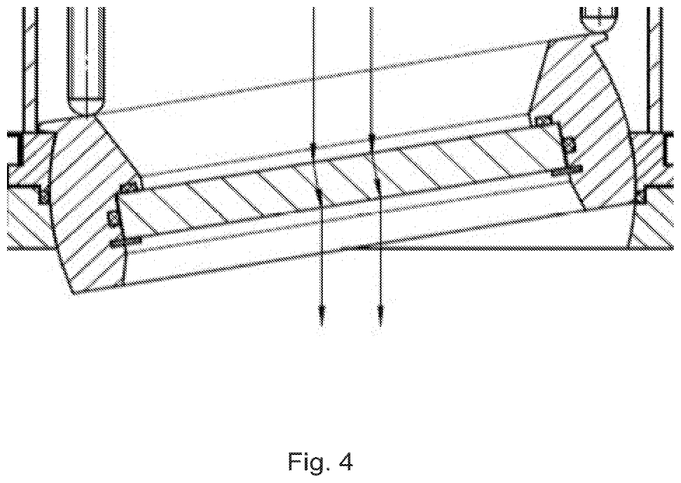

FIG. 4 shows a section of a radar sensor with mounting device in the area of the sensor mounting. This is the embodiment already described above, in which the mounting device represents the “sensor housing” and the electronics of the sensor are movably mounted in the joint socket of the mounting device.

Supplementally, it should be noted that “comprising” and “having” do not exclude other elements or steps, and the indefinite articles “a” or “an” do not exclude a plurality. It should further be noted that features or steps that have been described with reference to any of the above embodiments may also be used in combination with other features or steps of other embodiments described above. Reference signs in the claims are not to be regarded as limitations.

1. Radar sensor (100) configured to measure a level or a limit level of a product (201) in a container (200), comprising:
a sensor housing (101), the outer contour of which has the shape of a spherical segment at least in a first partial region (102) of the sensor housing, which is configured to rotatably support the radar sensor in a corresponding hollow spherical segment (301) of a mounting device (104);
an electronics unit (105) configured to generate a measurement signal;
an antenna unit (106) configured to radiate the measurement signal and to receive the measurement signal reflected from a product surface;
wherein the electronic unit and the antenna unit are arranged in the housing.

2. Radar sensor (100) according to claim 1,
wherein the outer contour of the sensor housing (101) is completely spherical.

3. Radar sensor (100) according to any one of the preceding claims,
wherein the sensor housing (101) is completely closed.

4. Radar sensor (100) according to any one of the preceding claims,
wherein the sensor housing (101) is made of plastic at least in the region of the antenna unit (106), so that the measurement signal can be radiated through the sensor housing.

5. Radar sensor (100) according to any one of the preceding claims,
wherein the sensor housing (101) cannot be opened non-destructively.

6. Radar sensor (100) according to any one of the preceding claims, configured as a stand-alone radar sensor with its own power supply.

7. Radar sensor (100) according to any one of the preceding claims, further comprising:
a radio interface (107) configured for wireless transmission of the radar sensor data to an external receiver.

8. Radar sensor (100) according to any one of the preceding claims,
where the center of gravity of the radar sensor is located below the center point of the sphere segment, so that the radar sensor aligns itself perpendicular to the product surface by means of gravity.

9. Radar sensor (100) according to any one of the preceding claims,
wherein a second portion (108) of the sensor housing (101) is made of a translucent material such that a display (109) of the radar sensor can be read through the sensor housing.

10. Radar sensor (100) according to any one of the preceding claims, configured for non-contact measurement of the filling level or limit level.

11. Mounting device (300), comprising a hollow sphere (301, 302) or at least one hollow sphere segment (301), configured for rotatably mounting a radar sensor (100) according to any of the preceding claims.

12. Mounting device (300) according to claim 11, embodied as a closed hollow sphere.

13. Mounting device (300) according to claim 11 or 12, wherein the hollow sphere segment (301) is made of opaque plastic.

14. Mounting device (300) according to any one of claims 11 to 13, wherein the hollow sphere (301, 302) is at least partially made of a translucent material such that a display (109) of the radar sensor (100) can be read through the hollow sphere (301, 302).

15. Mounting device (300) according to any one of claims 11 to 14, comprising a mounting flange for attachment to the opening of a container. cm 16. Mounting device (300) according to any one of claims 11 to 15, comprising a retaining arm (310) or an internal thread for attaching a retaining arm (310).

17. Mounting device (300) according to any one of claims 11 to 16, wherein the mounting device comprises a locking element (311) configured to fix the sensor (100) in the mounting device.

18. Mounting device (300) according to any one of claims 11 to 17, wherein the mounting device comprises an alignment member (312) configured to align the sensor (100) in the mounting device.

19. Mounting device (300) according to any one of claims 11 to 18, comprising a sensor (100) disposed therein.

20. Mounting device (300) according to claim 19, wherein the sensor (100) is a level meter, a point level sensor, a pressure sensor, or a flow sensor.

21. Use of a mounting device (300) according to any one of claims 11 to 20 for mounting a sensor (100) selectively on a side wall of a container (200) or the ceiling of the container.

22. Container (200) having a mounting device (300) attached thereto according to any one of claims 11 to 20.

23. Method of mounting a sensor (100) to a container (200), comprising the steps of:
Placing the sensor in a fully enclosed mounting device (300);
Attaching the mounting device to the container;
Aligning of the sensor.

24. Method according to claim 23, wherein aligning of the sensor (100) is performed by gravity.
